(19) United States
(12) Patent Application Publication
(10) Pub. No.: US 2026/0244770 A1
(43) Pub. Date: Aug. 20, 2026

(54) METHOD AND APPARATUS FOR SWITCHING OPERATING MODE OF SMART TERMINAL

(71) Applicant: SHENZHEN AURORA TECHNOLOGY LIMITED, Shenzhen (CN)

(72) Inventor: Qingbo XIE, Shenzhen (CN)

(73) Assignee: SHENZHEN AURORA TECHNOLOGY LIMITED, Shenzhen (CN)

(21) Appl. No.: 19/328,626

(22) Filed: Sep. 15, 2025

(30) Foreign Application Priority Data
Feb. 20, 2025 (CN) 202510187636.X

(51) Int. Cl. G06F 21/60; H04M 1/72463

(52) U.S. Cl. CPC G06F 21/604; H04M 1/724631; G06F 2221/2141

(57) ABSTRACT

A method for switching an operating mode of a smart terminal includes: assessing security coefficients of privacy security projects and financial security projects in the smart terminal under normal mode; obtaining first information from the smart terminal; determining whether the smart terminal meets the active activation conditions of any security mode based on the first information; If so, switching the smart terminal to the security mode corresponding to the active activation condition; otherwise, monitoring an unlocking process of the smart terminal in real time; when any passive activation condition is matched during the unlocking process, switching the smart terminal to the security mode corresponding to the passive activation condition; when the smart terminal is in any security mode, obtaining second information of the smart terminal, and executing the security measures corresponding to the security mode based on the second information.

### CROSS-REFERENCE TO RELATED APPLICATIONS

This application claims priority to Chinese Patent Application No. 202510187636.X, filed on February 20, 2025, the entire contents of which are incorporated herein by reference.

### TECHNICAL FIELD

The present application relates to the field of smart terminal security protection, and in particular relates to a method and an apparatus for switching an operating mode of a smart terminal.

### BACKGROUND

With the rapid development of information technology, smart terminals have become an indispensable part of people’s daily lives and work. Whether it is smartphones, tablets, or laptops, these devices store a large amount of personal data, including but not limited to financial information, privacy data, health records, and social media accounts. However, as these devices become increasingly comprehensive and their usage scenarios diversify, security threats have become more complex and difficult to prevent. Currently, smartphones and other smart terminals are often linked to various bank cards. If a user’s device is compromised, attackers can easily access financial information and privacy data through such smart terminals, which puts users’ personal wealth security and privacy security at great risk.

Existing security measures are typically focused on a single dimension, such as password protection or simple firewall settings, and cannot comprehensively cover a plurality of potential security threats. Traditional security measures primarily rely on simple authentication methods such as password protection, fingerprint recognition, or facial recognition. While these methods have improved security to some extent, they can only prevent unauthorized physical access. Furthermore, most existing security strategies are static, meaning that once set, they are difficult to change and cannot adapt to changing usage environments and potential threats.

### SUMMARY

Based on the problems existing in the related art, the present application provides a method and an apparatus for switching an operating mode of a smart terminal. The specific solution is as follows

The present application proposes a method and an apparatus for switching the operating mode of a smart terminal. Through multi-level security mode configuration, dynamic adjustment mechanisms, personalized protection, and comprehensive environmental perception capabilities, the security and user experience of smart terminals are significantly improved. Not only can unauthorized access and malicious behavior be effectively prevented, but flexible and accurate security protection can also be provided according to the actual needs of users, ensuring that devices obtain the best security protection in various application scenarios. By evaluating the security coefficient of the smart terminal in normal mode and pre-configuring a plurality of security modes with higher security coefficients, the system provides multi-level security protection.

Different security modes correspond to different active activation conditions, passive activation conditions, and security measures, ensuring that the device can obtain appropriate protection in any situation. The system can monitor user operation data and environmental data in real time, identify abnormal behavior, and automatically switch to the corresponding security mode. For example, when a plurality of unlock attempts are detected or a preset non-habitual password is used for unlocking, the system immediately implements stricter security measures to prevent unauthorized access. By analyzing users’ historical operation data, the system extracts their operation habits and automatically executes corresponding security measures when current operation data deviates from users’ operation habits. This personalized protection mechanism better adapts to users' actual usage scenarios, providing precise security protection. Based on the user’s access intention, the system can dynamically adjust the access permissions for privacy security projects and financial security projects. By constructing an evaluation system based on the quantity of accessible security projects and their access permissions, the system can quantitatively evaluate the security coefficient of smart terminals in different security modes. This provides a scientific basis for subsequent security mode configuration and adjustments, ensuring the reliability and effectiveness of the system. The system can continuously collect user feedback and the latest statistical data to dynamically adjust preset difference and other key parameters, achieving continuous optimization. This data-driven decision support mechanism enables the system to continuously improve as usage condition changes, always maintaining optimal security performance.

To make the above objectives, features, and advantages of the present application more clear and understandable, the following detailed description is provided with reference to preferred embodiments and the accompanying drawings.

### BRIEF DESCRIPTION OF THE DRAWINGS

To more clearly illustrate the technical solutions of the embodiments of the present application, the following is a brief introduction to the figures used in the embodiments. It should be understood that the following figures only illustrate certain embodiments of the present application and should not be regarded as limiting the scope thereof. For those skilled in the art, other related figures can be obtained based on these figures without creative labor.

FIG. 1 is a flowchart of a method for switching an operating mode of a smart terminal according to an embodiment of the present application.

FIG. 2 is a flowchart of the method for switching the operating mode of the smart terminal according to another embodiment of the present application.

FIG. 3 is a flowchart of the method for switching the operating mode of the smart terminal according to another embodiment of the present application.

FIG. 4 is a flowchart of the method for switching the operating mode of the smart terminal according to another embodiment of the present application.

FIG. 5 is a schematic diagram of an apparatus for switching the operating mode of the smart terminal according to another embodiment of the present application.

The realization, functional features, and advantages of the purpose of the present application will be further explained in conjunction with the embodiments with reference to the drawings.

### DETAILED DESCRIPTION OF THE EMBODIMENTS

The technical solutions of the embodiments of the present application will be described in detail below with reference to the accompanying drawings. It should be noted that the embodiments described herein are only some of the embodiments of the present application and not all of them. All other embodiments obtained by those skilled in the art without creative labor based on the embodiments of the present application are within the scope of protection of the present application.

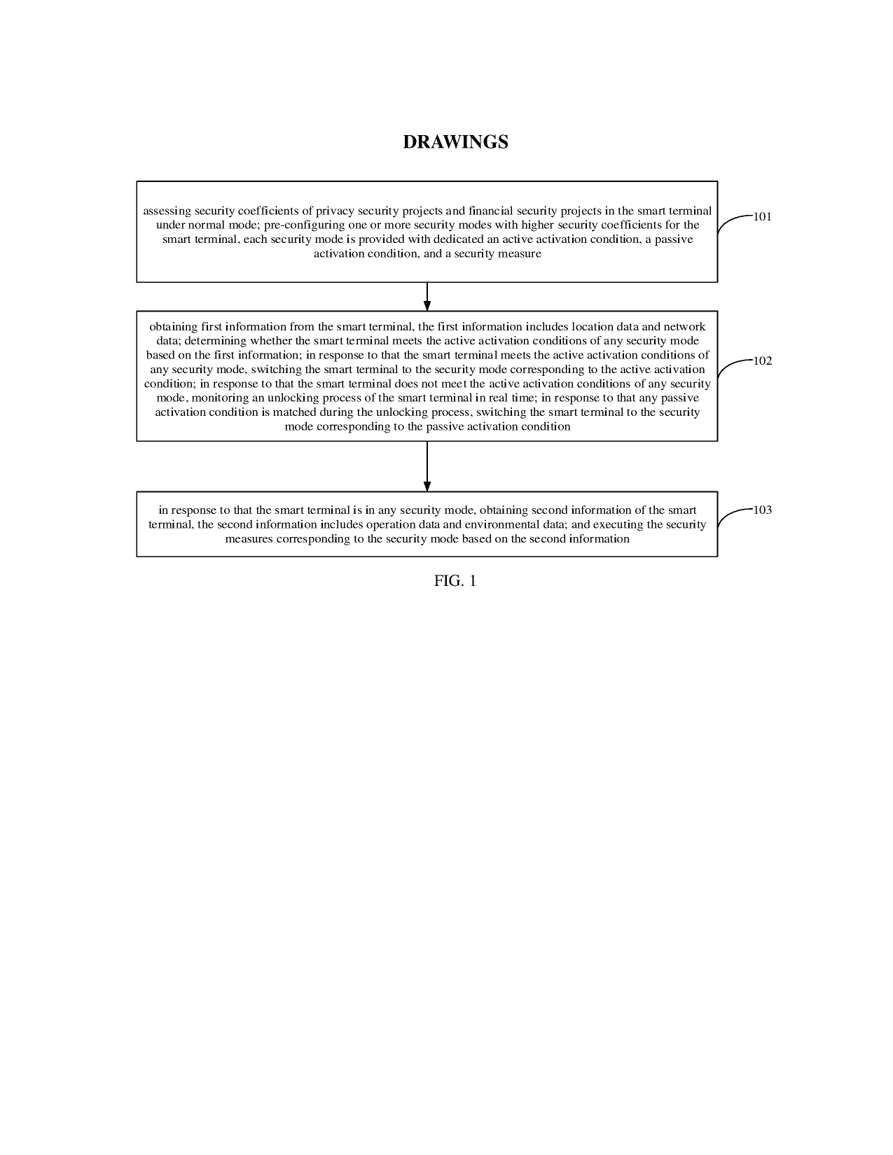

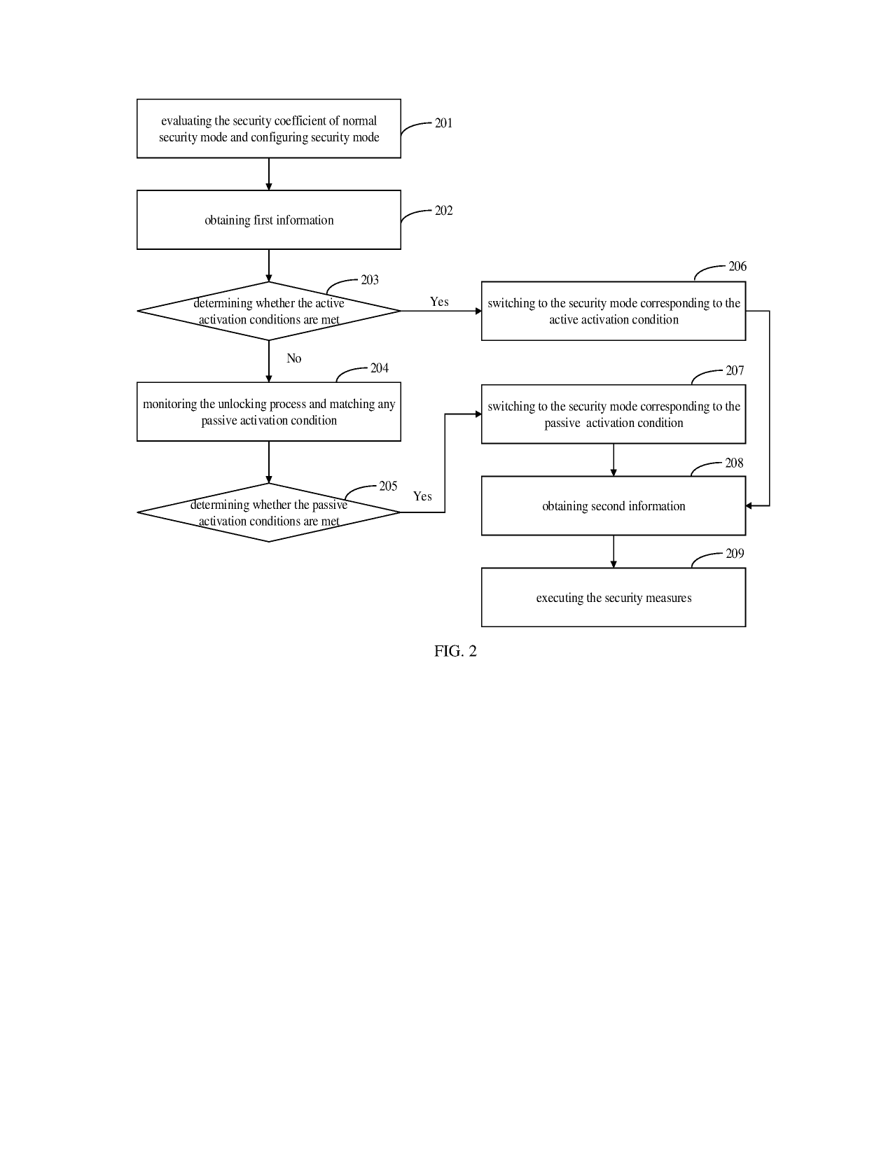

The present application provides a method for switching an operating mode of a smart terminal. By comprehensively assessing privacy security projects and financial security projects in the smart terminal and pre-configuring a plurality of security modes with higher security coefficients based on the assessment, the method significantly enhances the security of the smart terminal when processing sensitive information. The flowchart of the method for switching the operating mode of the smart terminal is shown in FIG. 1 and FIG. 2. As shown in FIG. 2, the method includes: step 201, evaluating the security coefficient of normal security mode and configuring security mode; step 202, obtaining first information; step 203, determining whether the active activation conditions are met; if yes, executing step 206, switching to the security mode corresponding to the active activation condition; if no, executing step 204, monitoring the unlocking process and matching any passive activation condition; after step 204, executing step 205, determining whether the passive activation conditions are met; if yes, executing step 207, switching to the security mode corresponding to the passive activation condition; after step 207, executing step 208, obtaining second information; and step 209, executing the security measures.

As shown in FIG. 1, the present application provides a method for switching the operating mode of the smart terminal, including the following steps:

Step 101, assessing security coefficients of privacy security projects and financial security projects in the smart terminal under normal mode; pre-configuring one or more security modes with higher security coefficients for the smart terminal, each security mode is provided with dedicated an active activation condition, a passive activation condition, and a security measure;

Step 102, obtaining first information from the smart terminal, the first information includes location data and network data; determining whether the smart terminal meets the active activation conditions of any security mode based on the first information; in response to that the smart terminal meets the active activation conditions of any security mode, switching the smart terminal to the security mode corresponding to the active activation condition; in response to that the smart terminal does not meet the active activation conditions of any security mode, monitoring an unlocking process of the smart terminal in real time; in response to that any passive activation condition is matched during the unlocking process, switching the smart terminal to the security mode corresponding to the passive activation condition; and

Step 103, in response to that the smart terminal is in any security mode, obtaining second information of the smart terminal, the second information includes operation data and environmental data; and executing the security measures corresponding to the security mode based on the second information.

The present application provides a method for switching the operating mode of a smart terminal, primarily used to enhance the security of smart terminals when processing financial and privacy information. This method can achieve this by assessing the security coefficient of the smart terminal in normal mode and pre-configuring one or more security modes with higher security coefficients based on the assessment. These security modes are switched automatically based on different active activation conditions or passive activation conditions. The smart terminal includes wearable devices, smartphones, tablets, and laptops, which are portable terminal devices that involve users’ personal privacy and some financial information.

In the present application, security modes are defined in terms of security projects, which can be specific software or related information within the software, such as bookmark information or browsing history. Upon entering a security mode, the smart terminal will only display information such as software that is permitted to be accessed in that mode to protect privacy and financial security. For example, in a high-level security mode, security projects such as banking apps on a smartphone will not be displayed or permitted to be accessed, and security projects containing privacy information, such as photo albums and social media apps, will not be displayed or permitted to be accessed.

Step 101 is the foundation of the method for switching the operating mode of a smart terminal. Its core lies in assessing the security coefficient of the smart terminal in normal mode and pre-configuring one or more security modes with higher security coefficients for the smart terminal.

In the present application, the smart terminal need to have certain capabilities, including: network connectivity, multitasking, user interface, sensor integration, and microphone and camera.

Network connectivity refers to connecting to the internet through Wi-Fi, cellular networks, or other methods.

Multitasking refers to the ability to run a plurality of applications simultaneously and handle different types of tasks.

User interface refers to providing a graphical user interface (GUI) for easy user operation.

Sensor integration refers to including a plurality of built-in sensors (such as global Positioning System, accelerometer, gyroscope, etc.), the sensors are configured to obtain environmental information.

Microphone and camera are used to obtain audio and video data from the device’s surroundings.

First, the system needs to identify and assess security projects related to financial (such as banking applications, payment platforms, etc.) and privacy (such as contact lists, text messages, photos, etc.) categories on smart terminals. These projects typically contain users’ most sensitive information and therefore require special attention to security. By clearly defining which projects belong to the financial and privacy categories, the system can provide more stringent security protection for these high-risk projects.

Security projects refer to the types of data stored or processed on smart terminals and their related access control mechanisms. These projects often involve users’ financial information and personal privacy, so they require special security protection measures. Specifically, security projects can be categorized into the following types.

### 1. Financial security projects

Banking apps: such as Alipay, WeChat Pay, and official apps of major banks.

Investment and financial management platforms: such as stock trading software and fund trading platforms.

Electronic wallets: such as Apple Pay, Google Wallet.

### 2. Privacy security projects

Contact List: including contact names, phone numbers, email addresses, and other information.

SMS and instant messaging records: such as SMS messages, WhatsApp, and WeChat chat records.

Personal photos and videos: private images and videos stored in photo albums.

Health data: such as step counts and heart rate data recorded by fitness trackers.

To protect these security projects, the system typically sets access permissions to restrict which applications or users can access this data and under what conditions. For example, password protection, which requires a password or fingerprint to access certain sensitive applications; encrypted storage, which uses encryption algorithms such as advanced encryption standard (AES) to encrypt sensitive data; and permission management, which assigns different access permissions based on application requirements, such as read-only permissions or full access permissions.

Based on the identified security projects, the system assesses the overall security coefficient of the smart terminal in normal mode. This includes, but is not limited to, access permission settings, encryption measures, and network connection security. The assessed security coefficient helps determine the current security coefficient of the smart terminal under normal usage conditions and provides a basis for further enhancing security. Based on the assessed security coefficient, the system pre-configures one or more security modes with higher security coefficients for the smart terminal.

A security mode is an operating state of a smart terminal that improves the security of the smart terminal by enabling specific security measures. Each security mode has its own active activation conditions, passive activation conditions, and corresponding security measures to address different levels of security threats. Smart terminals, security projects, and security modes are an interconnected whole. Smart terminals serve as carriers for various security projects, while security modes are security strategies that are dynamically adjusted according to different usage scenarios and potential threats. This design not only improves the security of smart terminals, but also effectively addresses various potential security threats without affecting the user experience.

Each security mode has specific security measures and activation conditions. A plurality of preset security modes allow smart terminals to automatically adjust to the most appropriate security level based on different usage scenarios and potential threats, thereby enhancing overall security. Each security mode has dedicated active activation conditions, which are typically triggered by user operations or environmental changes. For example, when a smart terminal connects to a risky network, the high security mode is automatically activated. When the smart terminal connects to a home network, the security mode is disabled or security mode with a lower security coefficient is activated. Similarly, by detecting the location of the smart terminal, the security mode is automatically switched. For example, when the smart terminal is at home, the medium security mode is activated; in public places, the high security mode is activated. By setting clear active activation conditions, the system can quickly switch to the corresponding security mode upon detecting specific environments or behaviors, promptly addressing potential threats.

In addition to active activation conditions, the system also sets passive activation conditions to automatically switch to a higher security mode when abnormal behavior is detected. For example, if the wrong password is entered three times in a row, high security mode is automatically activated. If the device is restarted or shut down a plurality of times in a short period, high security mode is activated. Passive activation conditions allow for immediate action when abnormal operations are detected, thereby preventing unauthorized access or malicious attacks. By setting both active and passive activation conditions, a dynamic response mechanism is achieved, enhancing the system’s adaptability and response speed.

Each security mode is equipped with dedicated security measures to further enhance the security of smart terminals. Specific security measures provide effective protection against different levels of security requirements, ensuring that user data is adequately protected under all circumstances.

Regarding the assessment of security coefficients and the construction of security modes. In an embodiment, the method further includes: obtaining the privacy security projects and financial security projects in the smart terminal, and determining access permissions for each security project; based on a quantity of accessible security projects and access permissions of the security projects, constructing an evaluation system to assess the security coefficient of the smart terminal; determining a normal mode of the smart terminal and evaluating a security coefficient of the smart terminal in the normal mode based on the evaluation system to obtain a first security coefficient; determining the access permissions for each security project and classifying all access permissions into different permission levels; classifying security projects based on whether the security projects related to privacy or financial information; based on the permission levels, project types, and the quantity of accessible security projects, constructing a plurality of security modes, the security coefficient of each security mode is greater than the first security coefficient.

First, identify all financial and privacy-related data or applications on the smart terminal and set specific access permissions for each security project, such as read, write, modify, or delete. This can be achieved by scanning the applications and stored data on the smart terminal and marking which ones belong to financial security projects and which ones belong to privacy security projects. For example, this can be done through application programming interface (API) calls or file system scans. These permissions are configured in the smart terminal’s settings interface or are managed dynamically via API.

In an embodiment, constructing an evaluation system to assess the security coefficient under normal conditions includes: based on the quantity of accessible security projects and access permissions of the security project, constructing an evaluation system to quantify the security level of smart terminals; and using the evaluation system to assess the overall security coefficient of smart terminals under normal conditions to obtain the first security coefficient. In an embodiment, scoring criteria is defined and scoring each security project based on its access permissions. For example, a 10-point scale is used, and each project is scored based on the security of its permissions. In an embodiment, summarizing the scores of all projects, calculating the total score, and dividing the total score by the maximum score to obtain the security coefficient. For example, if the total score is 35 points and the maximum score is 50 points, the security coefficient is 70%.

In an embodiment, classifying all security projects related to access permissions into different levels based on their security. For example, classifying all security projects into low, medium, and high levels. Security projects requiring two-factor authentication are classified as high level, those requiring only password verification are classified as medium level, and those requiring no verification are classified as low level. Projects are classified based on their content into financial security projects or privacy security projects. For example, banking applications and payment platforms are classified as financial security projects, while contact lists and photo albums are classified as privacy security projects.

In an embodiment, security modes are as follows.

### 1. High security mode

Permission Level: all security projects require two-factor authentication.

Project Type: all financial security projects and privacy security projects are enabled with the highest level of protection.

Security coefficient: assumed to be 85%.

Active activation conditions: connected to the company’s internal network and located in the office.

Passive activation conditions: a plurality of failed unlock attempts, frequent reboots, or shutdowns.

Security Measures: which enable two-factor authentication, restrict external device connections, and enforce encryption for all communications.

### 2. Medium Security Mode

Permission level: some security projects require fingerprint or facial recognition, while others require password verification.

Project type: financial security projects corresponding to higher protection, while privacy security projects corresponding to medium protection.

Security coefficient: assumed to be 80%.

Active activation conditions: connected to the home Wi-Fi network and located at home.

Passive activation conditions: abnormal behavior is detected (e.g., frequent app switching within a short period).

Security Measures: which enable fingerprint recognition, restrict background activities of certain apps, and perform regular data backups.

### 3. Low security mode

Permission level: most security projects require password verification, while some security projects do not require verification.

Project type: financial security projects corresponding to basic protection, while privacy security projects corresponding to lower protection.

Security coefficient: assumed to be 75%.

Active activation conditions: connected to a public Wi-Fi network, located in a public place.

Passive activation conditions: device has not been used for an extended period (e.g., over 30 minutes of inactivity).

Security Measures: which enable password protection, automatic screen lock, and prompt users to be mindful of network security.

Step 102 is a critical part of the method for switching the operating mode of the smart terminal. Step 102 includes: obtaining the first information of the smart terminal (such as location data and network data) and determining whether the smart terminal meets the active activation conditions of any security mode based on the first information. If so, switching to the corresponding security mode; otherwise, monitoring the unlocking process of the smart terminal in real time and switching the operating modes when the passive activation conditions are met.

The first information refers to various data related to the current state of the smart terminal, primarily including location data and network data. Location data can be location information provided by Global Positioning System (GPS) coordinates, Wi-Fi positioning, or Bluetooth beacons. Network data includes the type of network currently connected to (e.g., Wi-Fi, 4G/5G) and its specific Service Set Identifier (SSID).

Active activation conditions refer to conditions under which the corresponding security mode is automatically activated when the smart terminal is in certain specific environments or connected to certain specific networks. For example, automatically activating high security mode when connected to the company’s internal network. In an embodiment, comparing the obtained first information with the active activation conditions of each security mode to determine whether any conditions are met. If the active activation conditions of a security mode are met, immediately switch to that security mode. For example, when the smart terminal connects to a Wi-Fi network named “company” and the location data indicates that the user is in the company office, the system automatically activates the high security mode. After the system detects that the active activation conditions of a specific security mode are met, it triggers the security mode switching. During the security mode switching, the system loads all configurations and security measures for that security mode and applies them to the smart terminal. Additionally, the system may prompt the user that the device has been switched to a new security mode.

Passive activation conditions refer to conditions that automatically activate the corresponding security mode when certain abnormal behaviors or operations are detected during the use of the smart terminal. For example, a plurality of failed unlock attempts, frequent reboots, or shutdowns. When the smart terminal does not meet any active activation conditions, the system will continue to monitor the user’s operations, especially the unlocking process. Monitored content may include the number of unlock attempts, the time interval between unlock attempts, and the number of incorrect password entries. If the system detects that the user’s behavior meets the passive activation conditions of a specific security mode during the monitoring process, the system will immediately switch to that security mode. For example, if the user enters the incorrect password three times in a row, the high security mode will be automatically activated, requiring the user to perform additional identity verification (such as fingerprint recognition or facial recognition).

Step 103 is a critical step in the method for switching the operating mode of the smart terminal, primarily including: obtaining the second information of the smart terminal, the second information includes operation data and environmental data, when the smart terminal is in any security mode, and executing corresponding security measures based on the second information. Based on the real-time operation data and environmental data obtained, the security measures under the current security mode can be dynamically adjusted to ensure that the smart terminal always remains in the optimal security state. The security coefficient can be automatically adjusted without affecting normal user use to enhance the security of the smart terminal and reduce potential security threats. Based on different users’ behavior habits and usage scenarios, personalized security protection strategies are provided. Through real-time monitoring and dynamic adjustment, potential security threats are addressed in time to protect users’ financial and privacy data. Certain security measures are enabled or disabled as needed to avoid unnecessary resource consumption and improve the overall performance of the smart terminal.

The second information refers to various data related to the current operation and environment of the smart terminal, primarily including operation data and environmental data. In an embodiment, operation data includes user operation on the smart terminal, such as the number of unlock attempts, the number of incorrect password entries, timestamps for application startup and shutdown, frequent application switching by the user, the frequency of smart terminal reboots, and the frequency of shutdowns. In practical applications, the operating system’s API interfaces are used to capture user operation behaviors, record the results of each unlock attempt, the timestamps of application launches and closures, the number of incorrect password entries, etc. Environmental data includes the current geographical location and residence duration of the smart terminal, image and sound information around the smart terminal, and weather information at the current geographical location. The GPS module is used to obtain the current location coordinates and record the residence duration at that location. Image information around the smart terminal is captured using the camera and the image information is analyzed using computer vision technology to identify potential security threats (e.g., whether unauthorized persons are approaching the smart terminal). Environmental sounds around the smart terminal are captured using the microphone and the audio analysis technology is used to detect abnormal sounds (e.g., alarm sounds, noisy sounds). Weather information (e.g., temperature, humidity, weather conditions) is obtained at the location of the smart terminal through network requests.

Each security mode has corresponding security measures to respond to different security threats. For example, high security mode may require two-factor authentication, restrict external smart terminal connections, and enforce encryption of all communications. Medium security mode may enable fingerprint recognition and restrict the background activities of certain applications. The system matches the second information obtained with the security measures of the current security mode to determine whether to enable or adjust certain security measures. If a potential security threat is detected (such as a plurality of failed unlock attempts or unusual sounds in the vicinity), the corresponding advanced security measures (such as two-factor authentication or screen locking) are immediately enabled. Based on real-time data, the system can dynamically adjust the security measures in the current security mode. For example, under low security mode, if unusual sounds are detected in the vicinity of the smart terminal, the system can temporarily upgrade to medium security mode and enable more security measures.

In a high security mode, when the system detects that the user has entered the wrong password three times in a row, it will automatically enable two-factor authentication and prompt the user to perform additional identity verification (such as fingerprint recognition or facial recognition). If abnormal sounds are detected in the vicinity of the smart terminal, the system will also temporarily lock the screen and send a notification to the administrator.

In a medium security mode, when the system detects that the user is frequently switching between apps within a short period of time, it will temporarily restrict certain apps from running in the background and enable fingerprint recognition. If the surrounding images show that a stranger is approaching the smart terminal, the system will prompt the user to be aware of their security and temporarily lock the screen.

In a low security mode, when the system detects that the smart terminal has not been used for an extended period (e.g., over 30 minutes of inactivity), it automatically locks the screen and prompts the user to be mindful of network security. If abnormal sounds are detected in the surroundings (e.g., alarm sounds), the system temporarily upgrades to medium security mode and enables additional security measures.

The core of step 103 lies in dynamically adjusting the security measures under the current security mode by obtaining real-time operation data and environmental data (i.e., secondary information) from the smart terminal, ensuring that the smart terminal is always in the optimal security state. This method not only enhances the security of smart terminals but also effectively addresses various potential security threats without compromising the user experience. Each security mode has clear security measures and dynamic adjustment mechanisms to ensure appropriate protection in different situations. This method achieves dynamic adaptability and multi-level protection, significantly enhancing the overall security of smart terminals.

In an embodiment, active activation conditions include connecting to a preset network and being located at a preset location. The passive activation conditions include detecting a plurality of unlock attempts within a preset duration, a plurality of reboots or shutdowns within a preset duration, unlocking with a preset non-habitual password, or pressing a preset button with a preset press patter.

The preset network is user-defined and can be either a secure or an insecure network. In practical applications, the preset network can be an unfamiliar, uncertified external network, such as a public network, which may pose risks of data breaches. When the smart terminal detects that it has connected to such a low-security network, it can switch to a security mode with higher security coefficient. Additionally, the preset network can also be maintained by trusted organizations or individuals and has a higher level of security. For example, internal company networks may be equipped with security facilities such as firewalls and intrusion detection systems to effectively prevent external attacks. In a preset network environment, smart terminals can more easily access enterprise resources and services while also better controlling the behavior and permissions of smart terminals. Similarly, preset locations are also user-defined and can be specific places such as companies, homes, or public places.

Passive activation conditions refer to situations in which, during the use of a smart terminal, the system automatically switches to the corresponding security mode when it detects abnormal behavior or potential security threats through real-time monitoring of the user’s operation and environmental data. In an embodiment, when passive activation conditions and/or active activation conditions are met, the smart terminal enters security mode without any prompts. Passive activation conditions are methods users use special passwords or special operations to prompt the smart terminal to enter security mode, such as different fingerprints, different passwords, different expressions, or pressing a specific button in a specific manner. For example, pressing the power button and volume button once, a plurality of times, or holding them down can control the smart terminal to enter security mode.

Non-habitual password refers to passwords that the user does not frequently use or non-habitual password combinations. Typically, users set a habitual password for daily unlocking of the smart terminal. A set of non-habitual passwords preset by the user may be considered a potential security threat when used to unlock the smart terminal. If the user uses a non-habitual password for unlocking, it may indicate that the smart terminal has been stolen or is at risk of other security threats. In the present application, the form of the non-habitual password include character passwords, graphic passwords, or biometric passwords.

Under normal circumstances, users can conveniently use their habitual passwords to unlock smart terminals and enjoy a seamless user experience. Only when abnormal behavior (such as using non-habitual passwords) is detected will the system automatically implement stricter security measures to ensure the security of the smart terminal. In an embodiment, the smart terminal is preset with a plurality of locking modes, each locking mode corresponding to a non-habitual password and a security mode, a form of the non-habitual password includes a character password, a graphic password, or a biometric password; the unlocking with the preset non-habitual password includes: in response to detecting the non-habitual password is configured to unlock the smart terminal, determining the locking mode corresponding to the non-habitual password to obtain a first locking mode; and after verification, switching the smart terminal to the security mode corresponding to the first locking mode. Each locking mode has one or more preset non-habitual passwords, which are different from the user’s habitual passwords. When the user unlocks the smart terminal using a non-habitual password, the system can recognize the password and automatically switch to the corresponding security mode based on its corresponding locking mode. Using a non-habitual password to unlock typically indicates that the smart terminal may be in an abnormal state (e.g., stolen or used by an unauthorized person), so higher security measures are required to protect the smart terminal and data. Different locking modes provide varying levels of security protection to accommodate different usage scenarios and potential threats. The verification method can be customized based on actual conditions, such as a prompt message or re-entering the same or a different password.

By presetting a plurality of locking modes, each locking mode corresponds to different security measures and security levels, allowing the system to provide appropriate protection based on specific circumstances. For example, high security mode may include two-factor authentication, restricting connections from external smart terminals, and encrypting all communications. Medium security mode may enable fingerprint recognition and restrict background activities of certain applications. Low security mode may only enable basic password protection and automatic screen locking. Users can preset different locking modes and non-habitual passwords according to their needs and usage scenarios. For example, they can use a habitual password to unlock smart terminals at home and use a preset non-habitual password to unlock smart terminals in the office or when traveling. This allows users to flexibly respond to various potential security threats in different environments. Each locking mode has specific security measures, and users can select the appropriate locking mode according to their actual needs. For example, when users expect their smart terminals to face higher security risks (such as when using them in public places), they can choose to use non-habitual passwords to trigger higher levels of security protection.

In an embodiment, the method further including: obtaining historical operation data of the same user on the smart terminal, analyzing the user’s operation habits from the historical operation data, the operation habits include data input methods and input speed, access frequency and access habits of security projects, and the holding posture of the smart terminal; in response to that the smart terminal is in any security mode, obtaining the user’s operation data on the smart terminal and analyzing whether the operation data conforms to the user’s operation habit; and in response to that the operation data does not conform to the user’s operation habit, executing the security measures corresponding to the security mode. By analyzing the user’s operation habits, the system can automatically execute corresponding security measures when abnormal operations are detected, thereby preventing unauthorized access or malicious behavior. Based on the user’s actual operation habits, the system can provide more precise security protection, thereby adapting to different usage scenarios and potential threats.

The system obtains and analyzes the historical operation data of the same user on the smart terminal to extract the user’s operation habits, such as data input methods and input speed, access frequency and access habits of security projects, and the holding posture of the smart terminal. Data input methods and input speed include typing speed and touchscreen click frequency. Access frequency and access habits of security projects include the access frequency of banking apps and login times. Holding postures of the smart terminal include sensor data reflecting the way the device is held. The system extracts the user’s operation habits, for example, the user typically enters passwords at a fast speed, the user accesses financial apps during fixed time slots each day, and the user prefers to operate the smart terminal with their left hand (using one hand). The system stores these operation habits as a habit model for subsequent comparison and anomaly detection.

When the smart terminal is in any security mode, the system will collect the user’s operation data in real time and compare it with the previously analyzed operation habits. If the current operation data does not match the user’s operation habits, the system will judge it as abnormal behavior and automatically execute the security measures corresponding to that security mode. In an embodiment, the system may require users to perform additional identity verification (such as fingerprint recognition or facial recognition) to confirm their identity. When the system detects that the current operation does not match the user’s habits, it automatically enables a higher security level to prevent unauthorized access to the smart terminal. For example, if a user’s smart terminal is suddenly lost and the person who finds it attempts to unlock the device, the system detects this abnormal behavior due to the user’s unusual operation methods (such as slow input speed or inconsistent holding posture) and immediately activates a high security mode. This requires additional identity verification (such as fingerprint recognition or facial recognition) and enables other advanced security measures (such as restricting connections from external smart terminals and encrypting all communications).

In an embodiment, the method further includes: in response to that the smart terminal is in any security mode, switching an accessible security project in the security mode to an unrestricted access project, and switching an inaccessible security projects in the security mode to a restricted access project; obtaining current user’s operation data on the smart terminal, and evaluating the current user’s access intention for privacy security projects and financial security projects by analyzing an access frequency of each restricted access project and unrestricted access project in the operation data, to obtain a first access intention and a second access intention; determining whether to classify the unrestricted access projects of financial security projects in the security mode into first restricted access projects based on the first access intention; determining whether to classify the unrestricted access projects of the privacy security projects in the security mode into the second restricted access projects based on the second access intention. By analyzing the user’s operation data, the system can real-time assess the user’s access intention and dynamically adjust the access permissions of privacy security projects and financial security projects based on these intents. This enables the system to provide a more flexible user experience while ensuring security. Based on the user’s actual access behavior, the system can more accurately determine which security projects need to be further restricted, thereby providing personalized security protection. When abnormal access intention is detected, the system automatically takes measures to classify certain unrestricted access projects into the restricted access projects to ensure the security of smart terminals. This not only enhances the security protection capabilities of smart terminals, but also provides personalized security measures based on actual needs to adapt to different usage scenarios and potential threats.

The system sets clear financial security projects and privacy security projects for each security mode and classifies them into restricted access projects and unrestricted access projects. Security projects that are allowed to be accessed are classified as unrestricted access projects, while security projects that are not allowed to be accessed are classified as restricted access projects. Unrestricted access projects, for example, projects that users can freely access, such as viewing weather information and browsing news. Restricted access projects, for example, security projects that require additional verification or are inaccessible to users, such as bank account information and personal information. When entering a specific security mode, the system initializes restricted access projects and unrestricted access projects based on preset rules.

The system collects user operation data in real time, including but not limited to: the number of times financial security projects were accessed, the number of times privacy security projects were accessed, the time and frequency of user operations, etc. The current operation data is compared with the preset restricted access projects and unrestricted access projects to calculate the number of times each project was accessed by the user. The system evaluates the user’s access intention for financial security projects and privacy security projects based on the user’s operation data. First access intention refers to the user’s intention to access financial security projects, such as frequent access to bank account information may indicate that the user has strong financial needs. Second access intention refers to the user’s intention to access privacy security projects, such as frequent access to personal information may indicate that the user has strong privacy needs. Differences or other standards can be preset to determine whether the user’s access intention is abnormal. For example, if a user frequently accesses a plurality of financial security projects within a short period of time, this may indicate a potential security threat.

Based on the assessed first and second access intentions, the system determines whether to classify certain unrestricted access projects into the restricted access projects. If the system detects abnormal access intentions for financial security projects (e.g., frequent access), it will classify certain financial security projects that were previously allowed to be accessed into the first restricted access projects. If the system detects abnormal access intentions for privacy security projects (e.g., frequent access), it will classify certain privacy projects that were previously allowed to be accessed into the second restricted access projects. After verification, the system updates the list of restricted access projects and unrestricted access projects under the current security mode and notifies users of the corresponding changes. When the system detects abnormal access intention from users, it automatically classifies certain unrestricted access projects into restricted access projects to prevent smart terminals from being accessed by unauthorized personnel. For example, while working in the company office, a user suddenly loses their smart terminal. The person who finds the smart terminal attempts to frequently access a plurality of financial security projects (such as bank account information). The system detects this abnormal behavior and immediately removes these financial security projects from the unrestricted access projects to restricted access projects, requiring additional authentication (such as fingerprint recognition or facial recognition) to access.

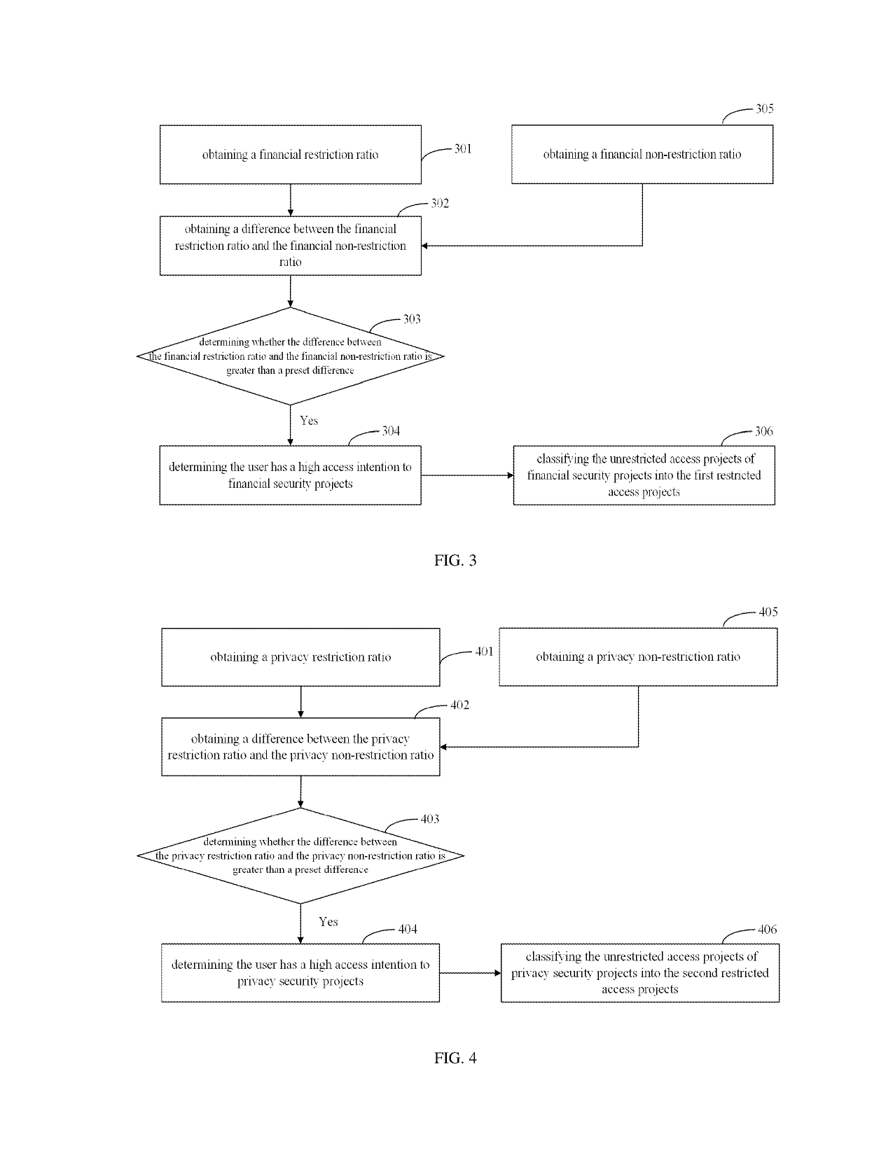

In an embodiment, the method further includes: obtaining a financial restriction ratio by dividing a number of accesses to restricted access projects of financial security projects in the operation data by a first total number; obtaining a financial non-restriction ratio by dividing a number of accesses to unrestricted access projects of financial security projects in the operation data by a second total number; obtaining the first access intention based on the financial restriction ratio and the financial non-restriction ratio; the first total number is a total number of accesses to each restricted access project in the operation data, and the second total number is a total number of accesses to each unrestricted access project in the operation data; obtaining a privacy restriction ratio by dividing a number of accesses to restricted access projects of privacy security projects in the operation data by the first total number; obtaining a privacy non-restriction ratio by dividing a number of accesses to unrestricted access projects of privacy security projects in the operation data by the second total number; and obtaining the second access intention based on the privacy restriction ratio and the privacy non-restriction ratio. The flowchart of the method for switching the operating mode of the smart terminal according to another embodiment of the present application is shown in FIG. 3, and the flowchart of the method for switching the operating mode of the smart terminal according to another embodiment of the present application is shown in FIG. 4. As shown in FIG. 3, the method includes: step 301, obtaining a financial restriction ratio; step 302, obtaining a difference between the financial restriction ratio and the financial non-restriction ratio; step 303, determining whether the difference between the financial restriction ratio and the financial non-restriction ratio is greater than a preset difference; if yes, executing step 304, determining the user has a high access intention to financial security projects; step 306, classifying the unrestricted access projects of financial security projects into the first restricted access projects. The method further includes step 305, obtaining a financial non-restriction ratio. In addition, after any one of step 301 and step 305 is executed, the method can enter the step 302. As shown in FIG. 4, the method includes: step 401, obtaining a privacy restriction ratio; step 402, obtaining a difference between the privacy restriction ratio and the privacy non-restriction ratio; step 403, determining whether the difference between the privacy restriction ratio and the privacy non-restriction ratio is greater than a preset difference; if yes, executing step 404, determining the user has a high access intention to privacy security projects; step 406, classifying the unrestricted access projects of privacy security projects into the second restricted access projects. The method further includes step 405, obtaining a privacy non-restriction ratio. In addition, after any one of step 401 and step 405 is executed, the method can enter the step 402.

The system divides the user’s operation data into a number of accesses to restricted access projects and unrestricted access projects, and further subdivides them according to financial security projects and privacy security projects. The first access intention is obtained by calculating the financial restriction ratio and the financial non-restriction ratio, and the second access intention is obtained by calculating the privacy restriction ratio and the privacy non-restriction ratio. Based on the calculated access intention (first access intention and second access intention), the system decides whether to adjust the access permissions of certain security projects to enhance security. When the system detects abnormal user access intention, it automatically classifies certain unrestricted access projects into restricted access projects to prevent unauthorized personnel from accessing sensitive information on smart terminals.

In an embodiment, the method further includes: in response to that a difference between the financial restriction ratio and the financial non-restriction ratio in the first access intention is greater than a preset difference, classifying the unrestricted access projects of financial security projects in the security mode into first restricted access projects; in response to that a difference between the privacy restriction ratio and the privacy non-restriction ratio in the second access intention is greater than a preset difference, classifying the unrestricted access projects of the privacy security projects in the current security mode into second restricted access projects. The preset difference is a critical difference value used by the system to determine whether a user’s access intention is abnormal. It determines under what circumstances the system will adjust certain unrestricted access projects to restricted access projects.

In an embodiment, the operation data classification specifically includes: taking the total number of accesses to each restricted access project in the operation data as the first total number, and taking the total number of accesses to each unrestricted access project in the operation data as the second total number.

In an embodiment, the financial ratio calculation includes:

obtaining a financial restriction ratio by dividing a number of accesses to restricted access projects of financial security projects by a first total number; and

obtaining a financial non-restriction ratio by dividing a number of accesses to unrestricted access projects of financial security projects by a second total number.

In an embodiment, the privacy ration calculation includes:

obtaining a privacy restriction ratio by dividing a number of accesses to privacy security projects by the first total number; and

obtaining a privacy non-restriction ratio by dividing a number of accesses to in the privacy security projects by the second total number.

In an embodiment, the access intention assessment includes:

Based on the financial restriction ratio and the financial non-restriction ratio, assessing the user’s access intention of financial security projects (first access intention). Based on the privacy restriction ratio and the privacy non-restriction ratio, assessing the user’s access intention of privacy security projects (second access intention).

In an embodiment, dynamic adjustment of access permissions includes:

based on the first access intention, determining whether to classify the unrestricted access projects of financial security projects into the first restricted access projects;

based on the second access intention, determining whether to classify the unrestricted access projects of privacy security projects into the second restricted access projects.

In an embodiment, while working in the company office, a user’s smart terminal is suddenly lost. The person who finds the smart terminal attempts to frequently access a plurality of financial security projects (e.g., bank account information).

In an embodiment, the operation data include first total number, second total number, the number of accesses to restricted access projects of financial security projects and the number of accesses to unrestricted access projects of financial security projects.

The first total number refers to a total number of accesses to each restricted access project is 50.

The second total number refers to a total number of accesses to each unrestricted access project is 100.

The number of accesses to restricted access projects of financial security projects: 30 times.

The number of accesses to unrestricted access projects of financial security projects: 70 times.

In an embodiment, ratios include financial restriction ratio and financial non-restriction ratio.

The financial restriction ratio=30/50, that is 60%.

The financial non-restriction ratio=70/100, that is 70%.

In an embodiment, access intention assessment includes the assessment of the first access intention.

The first access intention, since the financial restriction ratio is high (60%), it indicates that users have strong financial needs and frequently access restricted access projects, which may require enhanced security measures.

The system detects that the user frequently accesses a plurality of financial security projects and determines this as abnormal behavior. The system automatically activates high security mode, requiring the user to undergo additional identity verification (such as fingerprint recognition or facial recognition), and moves these financial security projects from unrestricted access projects to restricted access projects to ensure the security of sensitive information.

Adjusting access permission for security projects based on access intention includes: monitoring users’ operation data in real time, obtaining the financial restriction ratio, the financial non-restriction ratio, the privacy restriction ratio and the privacy non-restriction ratio, assessing users’ access intention, and dynamically adjusting access permissions. This method not only enhances the security protection capabilities of smart terminals but also provides personalized security measures based on actual needs, adapting to different usage scenarios and potential threats.

The setting of preset difference requires comprehensive consideration of a plurality of factors, including security requirements, user experience, historical data, and statistical analysis.

In an embodiment, analyzing based on historical data includes: collecting a large amount of user operation data, including normal access behavior and abnormal access behavior. By analyzing this data, the differences between normal and abnormal access behavior are identified. Performing statistical analysis on historical data to obtain the financial restriction ratio, the financial non-restriction ratio, the privacy restriction ratio, the privacy non-restriction ratio, the difference between the financial restriction ratio and the financial non-restriction ratio and the difference between the privacy restriction ratio and the privacy non-restriction ratio. A reasonable difference range can be determined so that most normal access behavior will not trigger permission adjustments, while abnormal access behavior can be effectively identified. Based on the statistical results, an appropriate difference value as the preset difference needed to be selected. The preset difference should ensure security while minimizing false positives (i.e., normal access behaviors being incorrectly classified as abnormal access behaviors). If the statistical results show that the difference between the financial restriction ratio and the financial non-restriction ratio for normal users typically does not exceed 5%, the preset difference can be set to 5% or slightly higher (e.g., 6%) to allow for some margin of error.

In an embodiment, accessing based on risk includes: classifying different risk levels according to different application scenarios and user groups. For example, enterprise users’ smart terminals may face higher security risks, while personal users’ smart terminals are relatively lower. Different preset differences for different risk levels are set. For high-risk scenarios, a lower preset difference is set to detect potential security threats more sensitively. For low-risk scenarios, a higher preset difference is set to reduce unnecessary permission adjustments. For example, the preset difference for high-risk scenarios (e.g., enterprise users) can be set to 3%, the preset difference for low-risk scenarios (e.g., ordinary individual users) can be set to 8%.

In practical applications, a conservative preset difference (e.g., 5%-10%) can be set initially to ensure system stability and security. This avoids excessive false alarms or missed alarms due to unreasonable initial settings. As the system runs longer, more user data and feedback information are gradually accumulated, and the preset difference can be dynamically adjusted. This makes the preset difference more in line with actual usage, thereby improving the accuracy of the system and the user experience. In addition to relying on preset difference, other indicators (such as the user’s geographic location and operating habits) can be combined for a multidimensional comprehensive assessment, thereby improving the overall judgment ability of the system and reducing the risk of misjudgment caused by a single indicator.

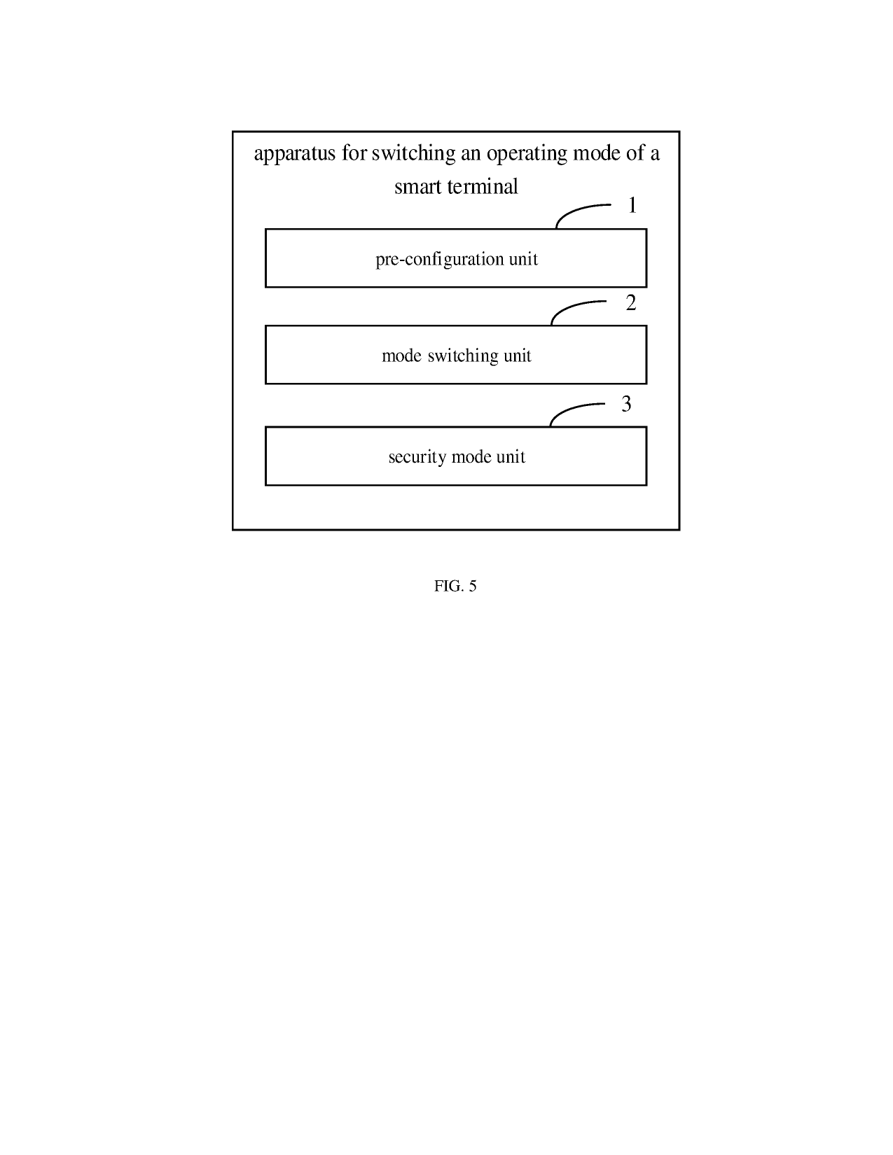

The present application provides an apparatus for switching the operating mode of the smart terminal, as shown in FIG. 5. The system includes a pre-configuration unit 1, a mode switching unit 2 and a security mode unit 3.

The pre-configuration unit 1 is configured to assess security coefficients of privacy security projects and financial security projects in the smart terminal under normal mode; pre-configure one or more security modes with higher security coefficients for the smart terminal, each security mode is provided with dedicated an active activation condition, a passive activation condition, and a security measure; obtain first information from the smart terminal, the first information includes location data and network data.

The mode switching unit 2 is configured to obtain first information from the smart terminal, the first information includes location data and network data; determine whether the smart terminal meets the active activation conditions of any security mode based on the first information; in response to that the smart terminal meets the active activation conditions of any security mode, to switch the smart terminal to the security mode corresponding to the active activation condition; in response to that the smart terminal does not meet the active activation conditions of any security mode, to monitor an unlocking process of the smart terminal in real time; in response to that any passive activation condition is matched during the unlocking process, to switch the smart terminal to the security mode corresponding to the passive activation condition.

The security mode unit 3 is configured to in response to that the smart terminal is in any security mode, obtain second information of the smart terminal, the second information includes operation data and environmental data; and to execute the security measures corresponding to the security mode based on the second information.

The present application provides a computer program product, which includes computer instructions stored in a computer-readable storage medium. The processor of a computer device reads the computer instructions from the computer-readable storage medium and executes the computer instructions, so that the computer device is able to execute the method for switching the operating mode of the smart terminal. That is, the method for switching the operating mode of the smart terminal can be applied to the computer program product, and executed within the computer program product.

The present application further provides a computer-readable storage medium storing a computer program, which, when executed by a processor, implements the steps of the method for switching the operating mode of the smart terminal as described above.

The computer-readable storage medium of the present application may adopt any combination of one or more computer-readable media. Computer-readable media may be computer-readable signal media or computer-readable storage media. Computer-readable storage media may include, but are not limited to: electrical, magnetic, optical, electromagnetic, infrared, or semiconductor systems, devices, or components, or any combination thereof. More specific examples of computer-readable storage media (non-exhaustive list) include: electrical connections with one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof. In the present application, a computer-readable storage medium may be any tangible medium that contains or stores a program that can be used by or in conjunction with an instruction execution system, device, or apparatus. The present application applies a method for switching the operating mode of the smart terminal to a computer-readable storage medium on which a computer program is stored. When executed by a processor, the program implements the steps of the method for switching the operating mode of the smart terminal provided by the present application, which is simple, fast, easy to store, and not easily lost.

The present application proposes a method and apparatus for switching the operating mode of a smart terminal. Through multi-level security mode configuration, dynamic adjustment mechanisms, personalized protection, and comprehensive environmental perception capabilities, the security and user experience of smart terminals are significantly improved. Not only can unauthorized access and malicious behavior be effectively prevented, but flexible and accurate security protection can also be provided according to the actual needs of users, ensuring that devices obtain the best security protection in various application scenarios.

Those skilled in the art will understand that the various modules of the present application may be implemented using a general-purpose computing system, they can be centralized in a single computing system or distributed across a network of a plurality of computing systems. They can be implemented using computer-executable program code, which can be stored in a storage system for execution by a computing system, or they can be fabricated as separate integrated circuit modules, or a plurality of modules or steps can be fabricated into a single integrated circuit module. Thus, the present application is not limited to any specific combination of hardware and software.

The above are merely some embodiments of the present application and the underlying technical principles employed. Those skilled in the art will understand that the present application is not limited to the specific embodiments described herein. Various obvious changes, adjustments, and substitutions may be made by those skilled in the art without departing from the scope of the present application. Therefore, although the present application has been described in detail through the above embodiments, the present application is not limited to the above embodiments. Without departing from the concept of the present application, the present application may include other equivalent embodiments, and the scope of the present application is determined by the scope of the appended claims.

The above disclosure is limited to several specific implementation scenarios of the present application. However, the present application is not limited thereto, and any changes that can be conceived by those skilled in the art should fall within the scope of protection of the present application.

What is claimed is:

1. A method for switching an operating mode of a smart terminal, comprising:
assessing security coefficients of privacy security projects and financial security projects in the smart terminal under a normal mode;
pre-configuring one or more security modes with higher security coefficients for the smart terminal, wherein each security mode is provided with dedicated an active activation condition, a passive activation condition, and a security measure;
obtaining first information from the smart terminal, the first information comprising location data and network data;
determining whether the smart terminal meets the active activation conditions of any security mode based on the first information;
in response to that the smart terminal meets the active activation conditions of any security mode, switching the smart terminal to the security mode corresponding to the active activation condition; in response to that the smart terminal does not meet the active activation conditions of any security mode, monitoring an unlocking process of the smart terminal in real time;
in response to that any passive activation condition is matched during the unlocking process, switching the smart terminal to the security mode corresponding to the passive activation condition;
in response to that the smart terminal is in any security mode, obtaining second information of the smart terminal, the second information comprising operation data and environmental data; and
executing the security measures corresponding to the security mode based on the second information.

2. The method according to claim 1, further comprising:
obtaining the privacy security projects and financial security projects in the smart terminal, and determining access permissions for each security project;
based on a quantity of accessible security projects and access permissions of the security projects, constructing an evaluation system to assess the security coefficient of the smart terminal;
determining the normal mode of the smart terminal and evaluating a security coefficient of the smart terminal in the normal mode based on the evaluation system to obtain a first security coefficient;
determining the access permissions for each security project and classifying all access permissions into different permission levels;
classifying security projects based on whether the security projects related to privacy or financial information;
based on the permission levels, project types, and the quantity of accessible security projects, constructing a plurality of security modes, wherein the security coefficient of each security mode is greater than the first security coefficient.

3. The method according to claim 1, wherein the active activation conditions comprise connecting to a preset network and being located at a preset location;
the passive activation conditions comprise detecting a plurality of unlock attempts within a preset duration, a plurality of reboots or shutdowns within a preset duration, unlocking with a preset non-habitual password, or pressing a preset button with a preset press pattern.

4. The method according to claim 3, wherein the smart terminal is preset with a plurality of locking modes, each locking mode corresponds to a non-habitual password and a security mode, a form of the non-habitual password comprises a character password, a graphic password, or a biometric password;
the unlocking with the preset non-habitual password comprises:
in response to detecting the non-habitual password is configured to unlock the smart terminal, determining the locking mode corresponding to the non-habitual password to obtain a first locking mode; and
after verification, switching the smart terminal to the security mode corresponding to the first locking mode.

5. The method according to claim 1, further comprising:
obtaining historical operation data of the same user on the smart terminal, analyzing the user’s operation habits from the historical operation data, wherein the operation habits comprise data input methods and input speed, access frequency and access habits of security projects, and the holding posture of the smart terminal;
in response to that the smart terminal is in any security mode, obtaining the user’s operation data on the smart terminal and analyzing whether the operation data conforms to the user’s operation habit; and
in response to that the operation data does not conform to the user’s operation habit, executing the security measures corresponding to the security mode.

6. The method according to claim 1, further comprising:
in response to that the smart terminal is in any security mode, switching an accessible security project in the security mode to an unrestricted access project, and switching an inaccessible security projects in the security mode to a restricted access project;
obtaining current user’s operation data on the smart terminal, and evaluating the current user’s access intention for privacy security projects and financial security projects by analyzing an access frequency of each restricted access project and unrestricted access project in the operation data, to obtain a first access intention and a second access intention;
determining whether to classify the unrestricted access projects of financial security projects in the security mode into first restricted access projects based on the first access intention;
determining whether to classify the unrestricted access projects of the privacy security projects in the security mode into second the restricted access projects based on the second access intention.

7. The method according to claim 6, further comprising:
obtaining a financial restriction ratio by dividing a number of accesses to restricted access projects of financial security projects in the operation data by a first total number;
obtaining a financial non-restriction ratio by dividing a number of accesses to unrestricted access projects of financial security projects in the operation data by a second total number;
obtaining the first access intention based on the financial restriction ratio and the financial non-restriction ratio; wherein the first total number is a total number of accesses to each restricted access project in the operation data, and the second total number is a total number of accesses to each unrestricted access project in the operation data;
obtaining a privacy restriction ratio by dividing a number of accesses to restricted access projects of privacy security projects in the operation data by the first total number;
obtaining a privacy non-restriction ratio by dividing a number of accesses to unrestricted access projects of privacy security projects in the operation data by the second total number; and
obtaining the second access intention based on the privacy restriction ratio and the privacy non-restriction ratio.

8. The method according to claim 7, further comprising:
in response to that a difference between the financial restriction ratio and the financial non-restriction ratio in the first access intention is greater than a preset difference, classifying the unrestricted access projects of financial security projects in the security mode into first restricted access projects;
in response to that a difference between the privacy restriction ratio and the privacy non-restriction ratio in the second access intention is greater than the preset difference, classifying the unrestricted access projects of privacy security projects in the current security mode into second restricted access projects.

9. The method according to claim 1, wherein the operation data comprises user operations on the smart terminal;
the environmental data comprises a current geographical location and residence duration of the smart terminal, image and sound information around the smart terminal, and weather information at the current geographical location.

10. An apparatus for switching an operating mode of a smart terminal, comprising:
a pre-configuration unit, configured to assess security coefficients of privacy security projects and financial security projects in the smart terminal under normal mode; pre-configure one or more security modes with higher security coefficients for the smart terminal, wherein each security mode is provided with dedicated an active activation condition, a passive activation condition, and a security measure;
a mode switching unit, configured to obtain first information from the smart terminal, the first information comprising location data and network data; determine whether the smart terminal meets the active activation conditions of any security mode based on the first information; in response to that the smart terminal meets the active activation conditions of any security mode, to switch the smart terminal to the security mode corresponding to the active activation condition; in response to that the smart terminal does not meet the active activation conditions of any security mode, to monitor an unlocking process of the smart terminal in real time; in response to that any passive activation condition is matched during the unlocking process, to switch the smart terminal to the security mode corresponding to the passive activation condition; and
a security mode unit, configured to in response to that the smart terminal is in any security mode, obtain second information of the smart terminal, the second information comprising operation data and environmental data; and to execute the security measures corresponding to the security mode based on the second information.
